(19) United States
(12) Patent Application Publication
(10) Pub. No.: US 2026/0121352 A1
(43) Pub. Date: Apr. 30, 2026

(54) CABLE ASSEMBLY AND CABLE BYPASS ASSEMBLY HAVING THE SAME

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventor: TERRANCE F. LITTLE, Fullerton, CA (US)

(21) Appl. No.: 18/925,965

(22) Filed: Oct. 24, 2024

(51) Int. Cl. H01R 13/6471; H01R 12/58; H01R 12/77; H01R 13/405; H01R 13/504; H01R 13/642

(52) U.S. Cl. CPC H01R 13/6471; H01R 12/58; H01R 12/775; H01R 13/405; H01R 13/504; H01R 13/642

(57) ABSTRACT

A cable assembly includes: a pair of signal contacts including signal contact portions and signal tails separated by a first pitch; an interposer including a pair of grounding contacts and a pair of signal conductors, the signal conductors including front signal conductor ends and rear signal conductor ends, the grounding contacts having grounding contact portions and grounding tails, the signal conductors being separated by a second pitch, the front signal conductor ends being electrically connected with the signal tails respectively; and a cable including an insulative portion with a pair of signal wires, and a ground member, the signal wires being separated by a third pitch, the ground member and the signal wires having free ends electrically connected with the grounding tails and the rear signal conductor ends respectively.

### BACKGROUND OF THE INVENTION

### Field of the Invention

The present invention relates generally to a cable bypass assembly, and more particularly to a cable bypass assembly used to transmit high frequency signals.

### Description of Related Arts

U.S. Pat. No. 10,680,364 discloses a communication system including a host circuit board having a cage member defining a module cavity, a receptacle assembly mounted to the host circuit board, and a pluggable module having a pluggable body loaded into the module cavity. The pluggable body has a mating interface along a bottom of the pluggable body facing the host circuit board. The pluggable module has a cable assembly having a cable and a cable connector at an end of the cable including signal contacts held by a contact holder that are terminated to signal conductors of the cable. The signal contacts have deflectable spring beams and mating interfaces along the deflectable spring beams exposed at the mating interface of the pluggable body to engage and directly mate with corresponding signal pads of the host circuit board.

U.S. Pat. No. 11,081,821 discloses a communication system including a circuit board having circuit board signal and ground contacts on the upper surface. The communication system includes a cable assembly having a housing holding a cable module with cables. A ground shield and signal contacts are electrically connected to the cables. The ground shield includes ground beams with ground mating interfaces coupled to corresponding circuit board ground contacts. Each signal contact has a terminating pad terminated to the cable conductor and a signal beam with a signal mating interface coupled to the circuit board signal contact. The housing includes contact channels receiving the signal and ground beams with the mating interfaces exposed for interfacing with the circuit board.

U.S. Pat. No. 11,670,879 discloses a midboard cable connector assembly with a board connector and a cable connector. The board connector has terminals precisely positioned with respect to engagement features. A cable connector likewise has terminals precisely positioned with respect to complementary engagement features. When the connectors are pressed together for mating, the terminals of one or both connectors deform, generating a force that separates the connectors until the engagement features engage and block further backward motion. As the mating position is defined by the locations of the engagement features, the connectors can be designed with low over travel and a resulting short stub length, which promotes high frequency performance. High frequency performance is further promoted by a ground conductor interconnecting the beams forming mating contact portions of ground terminals to reduce the length of unconnected segments and by a cable clamp plate with compliant compression features that reduce distortion of the cables.

### SUMMARY OF THE INVENTION

A main object of the present invention is to provide a cable bypass assembly having a good electrical performance.

To achieve the above object, a cable bypass assembly adapted for mating between a first mating connector and a second mating connector near a chip of a device comprises: a connector housing adapted for mating with the first mating connector; and a plurality of cable assemblies received in the connector housing, each of the cable assemblies comprising: a plurality of pairs of signal contacts arranged in a row, each of the signal contacts comprising a signal contact portion and a signal tail; an interposer comprising a plurality of grounding contacts and a plurality of pairs of signal conductors, each pair of the signal conductors disposed between adjacent two of the grounding contacts, each of the signal conductors comprising a front signal conductor end and a rear signal conductor end, each of the grounding contacts comprising a grounding contact portion extending forwardly beyond the front signal conductor end and a grounding tail, two signal contact portions of each pair of the signal contacts disposed between two adjacent grounding contact portions, the front signal conductor ends being electrically connected with the signal tails respectively; and a plurality of cables each comprising an insulative portion with a pair of associated signal wires extending lengthwise through the insulative portion, and a ground member associated with the pair of signal wires, the ground member and the signal wires having opposed first and second free ends, the first free ends of the ground member and the signal conductors being electrically connected with the grounding tails and the rear signal conductor ends respectively, the second free ends of the ground member and the signal conductors being electrically coupled to the second mating connector.

Compared to prior art, the cable bypass assembly comprises an interposer connected between the signal contacts and the cables that has a good electrical performance for transmitting high speed signal.

### BRIEF DESCRIPTION OF THE DRAWING

FIG. 1 is a perspective view a cable bypass assembly according to the first embodiment of present invention;

FIG. 2 is another perspective view of the cable bypass assembly of FIG. 1;

FIG. 3 is a perspective view of the cable bypass assembly of FIG. 1 with the insulative housing being removed;

FIG. 4 is another perspective view of the cable bypass assembly of FIG. 3;

FIG. 5 is a partly exploded view of the cable bypass assembly of FIG. 3;

FIG. 6 is another partly exploded view of the cable bypass assembly of FIG. 5;

FIG. 7 is a perspective view of a cable assembly of the cable bypass assembly of FIG. 1;

FIG. 8 is another perspective view of the cable assembly of FIG. 7;

FIG. 9 is a partly exploded view of the cable assembly of FIG. 8;

FIG. 10 is another partly exploded view of the cable assembly of FIG. 9;

FIG. 11 is further partly exploded view of the cable assembly of FIG. 9 with the signal contacts, insulative member, lower signal contacts and lower insulative member being removed;

FIG. 12 is another further partly exploded view of the cable assembly of FIG. 11;

FIG. 13 is a cross-sectional view of the cable bypass assembly taken along line A-A of FIG. 1;

FIG. 14 is a top view of signal conductors and grounding contacts molded with an insulative body, and signal contacts molded with an insulative member of the cable assembly of FIG. 9;

FIG. 15 is a bottom view of lower signal conductors and lower grounding contacts molded with a lower insulative body, and lower signal contacts molded with a lower insulative member of the cable assembly of FIG. 9;

FIG. 16 is a perspective view of a second embodiment of the cable assembly;

FIG. 17 is a cross-sectional view of the second embodiment of the cable assembly taken along line B-B of FIG. 16;

FIG. 18 is a perspective view of a third embodiment of the cable assembly; and

FIG. 19 is perspective view of a conductive member of the third embodiment of the cable assembly of FIG. 18.

### DETAILED DESCRIPTION OF THE PREFERRED EMBODIMENT

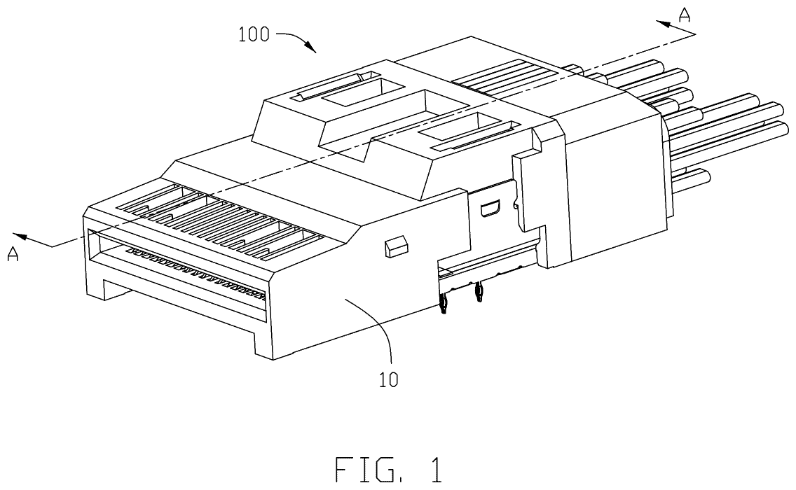

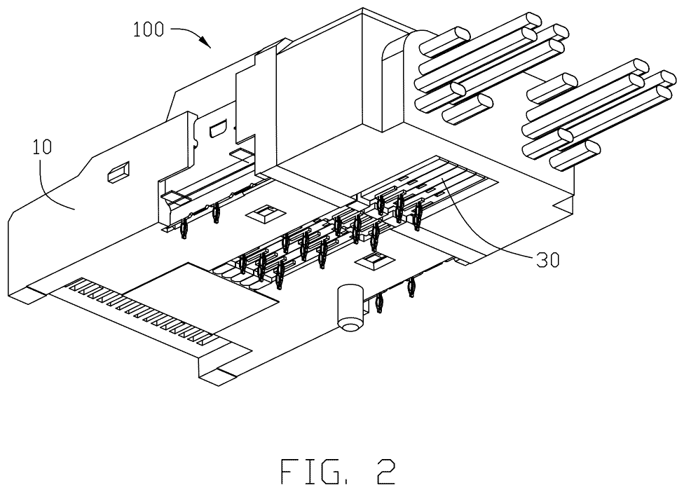

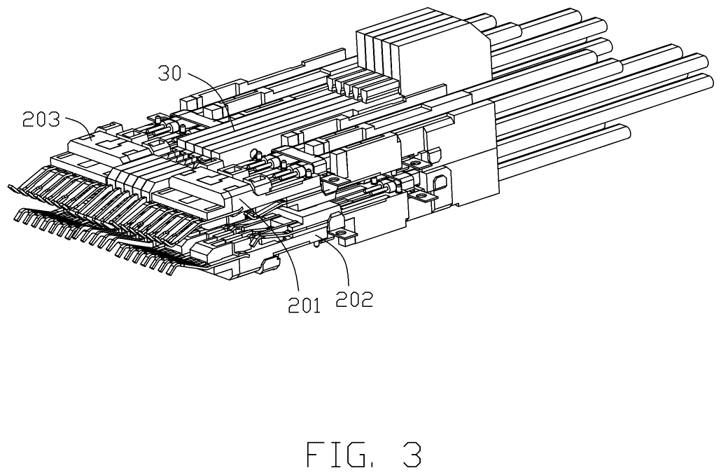

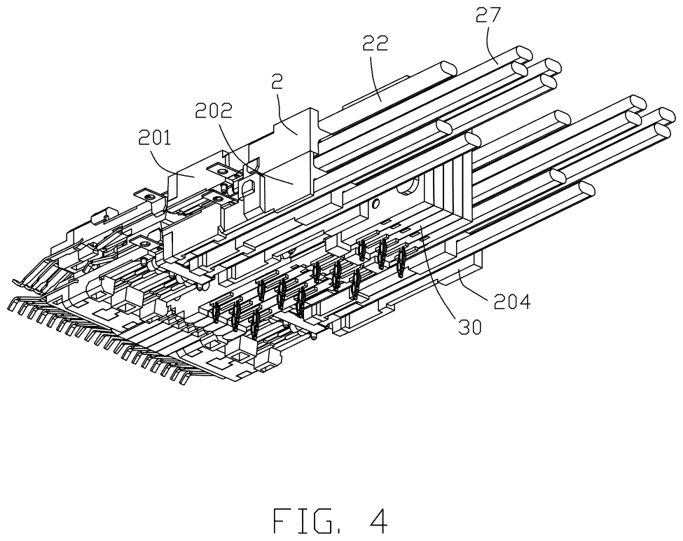

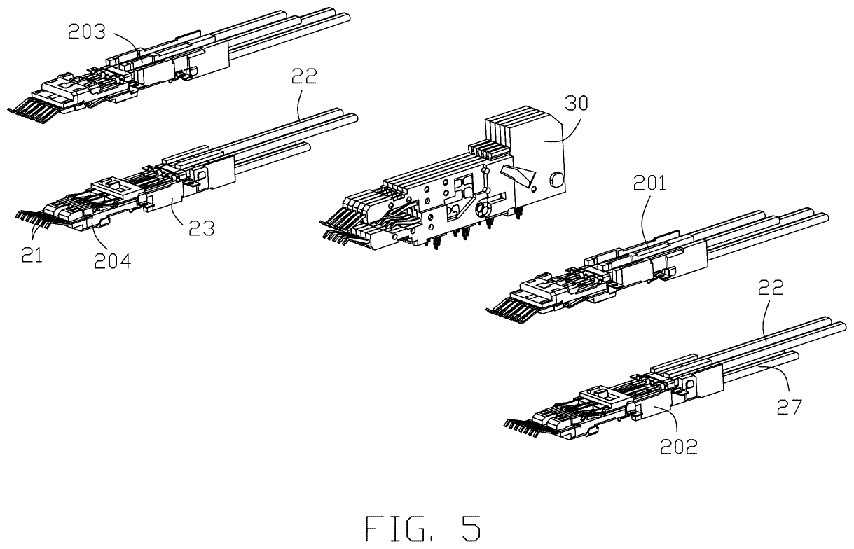

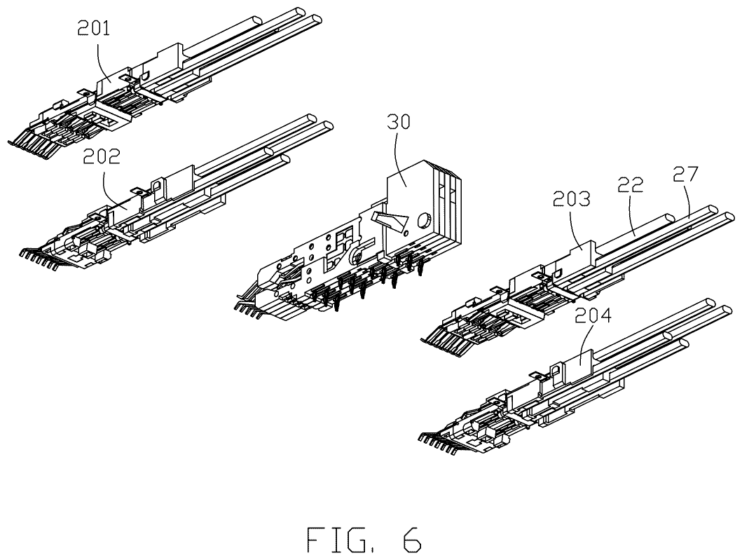

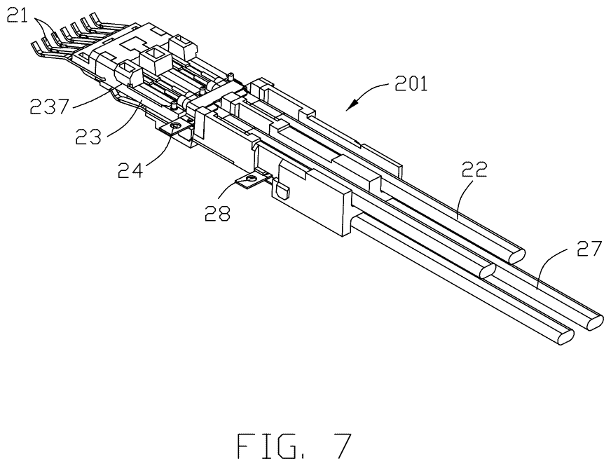

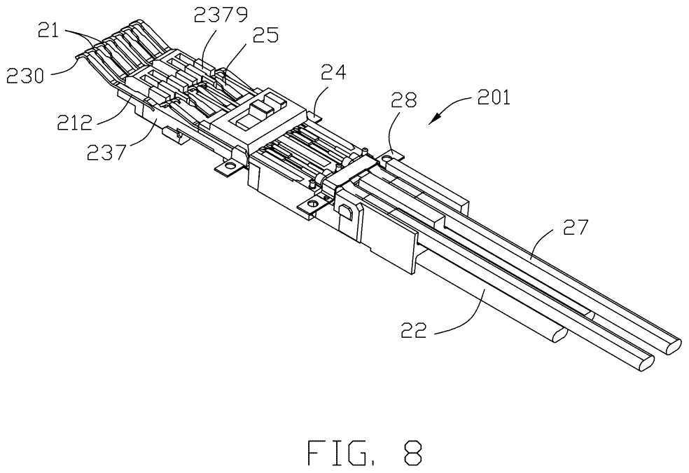

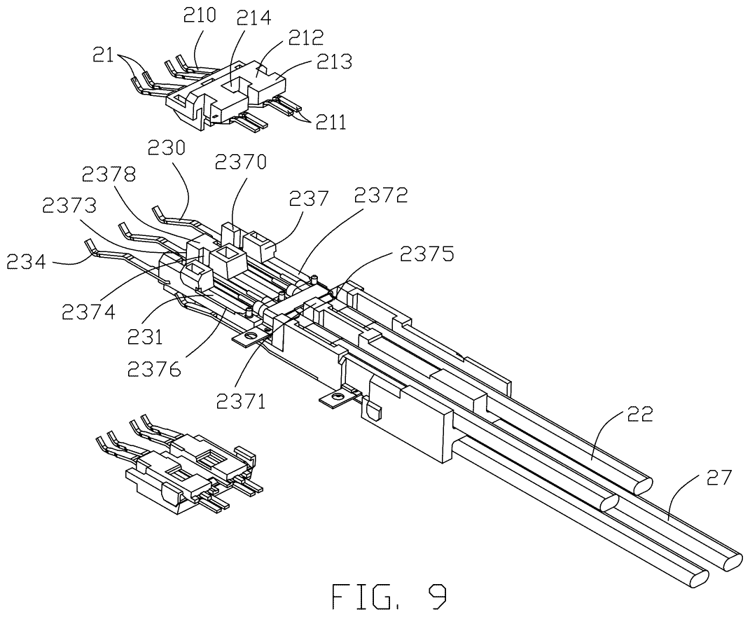

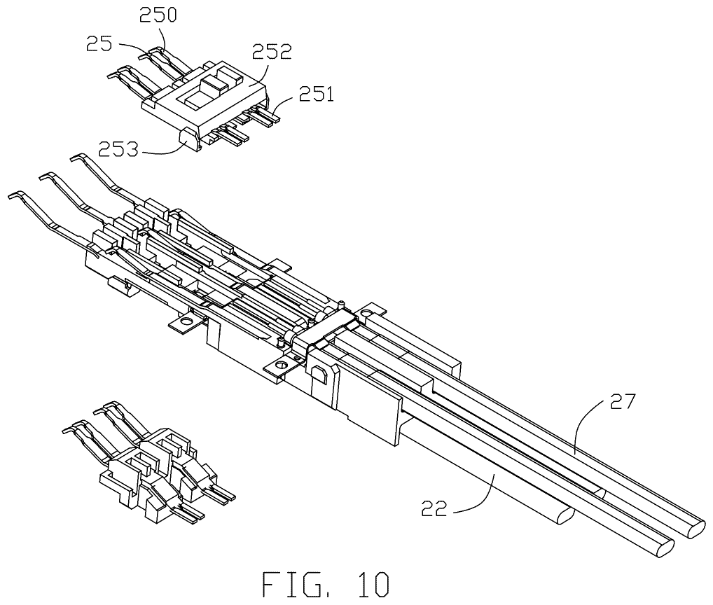

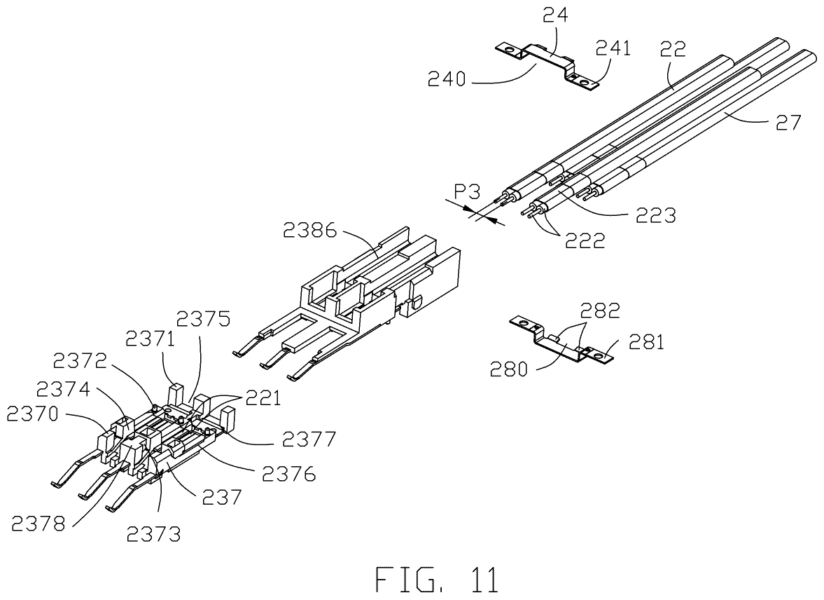

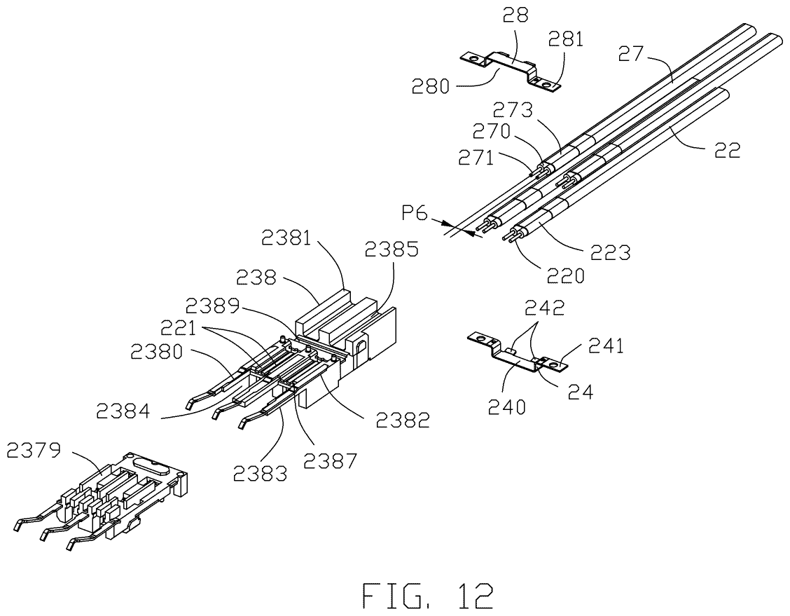

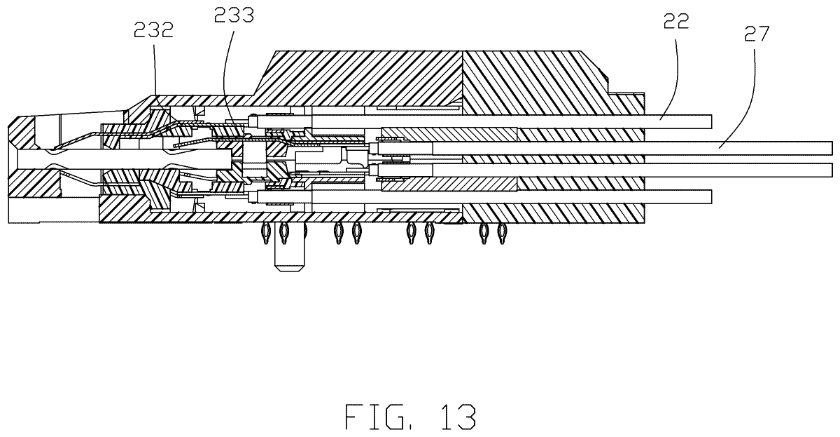

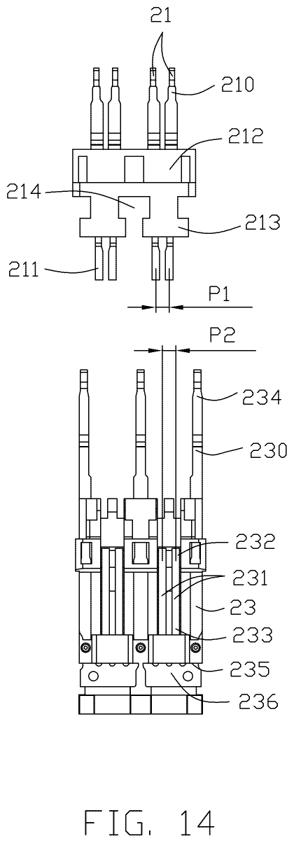

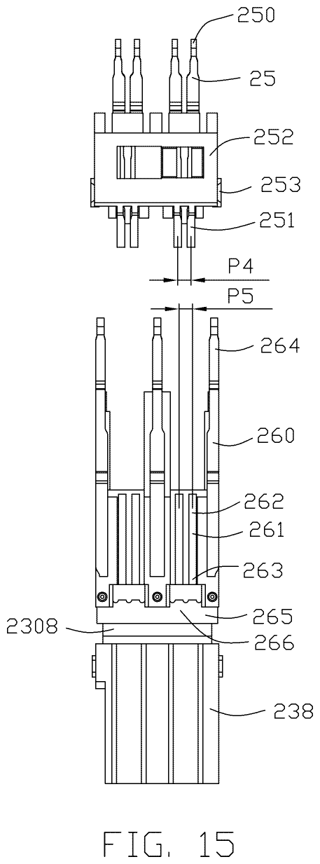

Referring to FIGS. 1-15, a cable bypass assembly 100 of the present invention is shown. The cable bypass assembly 100 adapted for mounted on a printed circuit board of a device and being mated or connected between a first mating connector and a second mating connector near a chip of the device. The cable bypass assembly 100 comprises a connector housing 10 formed by insulative material adapted for mating with the first mating connector, and a plurality of cable assemblies 20 received in the connector housing 10. Each of the cable assemblies 20 comprises a plurality of pairs of signal contacts 21 arranged in a row for transmitting high speed differential signal, a plurality of cables 22, and an interposer 23 connected between the signal contacts 21 and the cables 22. The cable assemblies 20 comprise a first cable assembly 201 and a second cable assembly 202 disposed opposite to the first cable assembly 201 to form a mating area for mating with the first mating connector. The cable assembly 20 may further comprise a third cable assembly 203 align with the first cable assembly 201 and a fourth cable assembly 204 align with the second cable 202 assembly. The cable bypass assembly 100 may further comprises a plurality of contact wafers 30 disposed between the first cable assembly 201 and the third cable assembly 202, and disposed between the second cable assembly 203 and the fourth cable assembly 204. The first to fourth cable assemblies 201-204 and the contact wafers 30 are cooperatively to form the mating area. The cable bypass assembly 100 may have an interface in accordance with a QSFP, QSFP DD, OSFP, OSFP XD, SFP, SFP DD, PCIe, MCIO, Backplane connector or any other types of high speed connector.

Each of the signal contacts 21 comprises a signal contact portion 210 and a signal tail 211 opposing the signal contact portion 210. The signal contacts 21 are molded in an insulative member 212. The signal tails 211 are separated by a first pitch P1. The insulative member 212 comprises a pair of T shaped blocks 213 and a T shaped slot 214 formed therebetween. The signal contact portion 210 extend forwardly beyond the insulative member 212 and exposed in the air. The signal tail 211 extend rearwardly beyond the insulative member 212 and exposed in the air.

The interposer 23 comprises a plurality of grounding contacts 230 and a plurality of pairs of signal conductors 231. Each pair of the signal conductors 231 is disposed between adjacent two of the grounding contacts 230. Each of the signal conductors 231 comprises a front signal conductor end 232 and a rear signal conductor end 233 opposing the front signal conductor end 232. Each of the grounding contacts 230 comprises a grounding contact portion 234 extending forwardly beyond the front signal conductor ends 232, and a grounding tail 235 opposing the grounding contact portion 234. The signal contact portions 210 of each pair of the signal contacts 21 are disposed between the two adjacent grounding contact portions 234 and arranged in a row. The pair of the signal conductors 231 are separated by a second pitch P2 being substantially equal to the first pitch P1. The front signal conductor ends 232 are electrically connected with the signal tails 211, respectively. The front signal conductor ends 232 are directly connected with the signal tails 211 by soldering, welding, etc. The grounding contacts 230 are integrated with each other by a connecting plant 236.

Each of the cables 22 comprises an insulative portion 220 with a pair of associated signal wires 221 extending lengthwise through the insulative portion 220, and a ground member 223 associated with the pair of signal wires 221. The pair of signal wires 221 are separated by a third pitch P3 being substantially equal to the second pitch P2. The ground member 223 and the signal wires 221 have opposed first and second free ends, the first free ends of the ground member 223 and the signal wires 221 being electrically connected with the grounding tails 235 and the rear signal conductor ends 233 respectively, the second free ends of the ground member 223 and signal wires 221 being electrically coupled to the second mating connector. The rear signal conductor ends 233 are directly connected with the signal wires 221 by soldering, welding, etc. Each of the cables 22 is devoid of drain wire. The free ends of the signal wires 221 directly contact with the rear signal conductor ends 233 devoid of bending.

Each of the cable assemblies 20 comprises a conductive member 24 comprising a receiving portion 240 for receiving and contacting the ground members 223 of the cables 22, two wing portions 241 connected to two opposing sides of the receiving portion 240, and a pair of spring tabs 242 extending rearwardly and downwardly from the receiving portion 240 for press against the cables 22.

The interposer 23 comprises an insulative body 237, the grounding contacts 230 and the signal conductors 231 being molded in the insulative body 237. The grounding contact portions 234 extend forwardly beyond a front end of the insulative body 237. The insulative body 237 comprises a front portion 2370, a rear portion 2371, and a middle portion 2372 connected therebetween. The front portion 2371 defines a pair of T shaped slots 2373, and a pair of front grooves 2374 in communication with the T shaped slots 2373 respectively. A T shaped block 2378 is formed between the pair of T shaped slots 2373. The rear portion 2371 defines a pair of rear grooves 2375. The middle portion 2372 comprises a flat portion 2376 and defines a slot 2377 disposed between the flat portion 2376 and the rear portion 2371. The front signal conductor ends 232 of each pair of the signal conductor 231 received in the front grooves 2374 and exposed in the air, respectively. The other portion of the signal conductor 231 are exposed in the air at the flat portion 2376. The connecting plant 236 of the grounding contacts 230 received in the slot 2377. The ground members 223 are received in the receiving portion 240 and disposed between the conductive member 24 and the connecting plant 236, the wing portions 241 directly connected with the flat portion 2376. Each of the cables 22 is received in and organized by the rear grooves 2375. The T shaped blocks 213 and the T shaped slot 214 of the insulative member 212 are mated with respective T shaped slots 2373 and the T shaped block 2378 of the insulative body 237 along a top to bottom direction to assemble the insulative member 212 with the insulative body 237 together and make the signal tails 211 to directly contact with the front signal conductor ends 232. The insulative body 237 defines a plurality of bottom grooves 2379.

Each of the cable assembly 20 further comprises a plurality of pairs of lower signal contacts 25 arranged in a row for transmitting high speed differential signal and being set below and behind the signal contacts 21. Each of the lower signal contacts 25 comprises lower signal contact portions 250 and lower signal tails 251 opposing the lower signal contact portions 250. The lower signal contacts 25 are molded in a lower insulative member 252. The lower signal tails are separated by a fourth pitch P4. The lower insulative member 252 comprises a pair of latch beams 253. The lower signal contact portion 250 extend forwardly beyond the lower insulative member 252 and exposed in the air. The lower signal tails 251 extend rearwardly beyond the lower insulative member 252 and exposed in the air. The lower signal contact portions 250 not extend beyond the signal contact portions 210, but the lower signal tails 251 extend beyond the signal tails 211.

The interposer 23 further comprises a plurality of lower grounding contacts 260 and a plurality of pairs of lower signal conductors 261 for transmitting high speed differential signal. Each pair of the lower signal conductors 261 is disposed between adjacent two of the lower grounding contacts 260. Each of the lower signal conductors 261 comprises lower front signal conductor end 262 and lower rear signal conductor end 263 opposing the lower front signal conductor end 262. Each of the lower grounding contacts 260 comprises a lower grounding contact portion 264 extending forwardly beyond the lower front signal conductor ends 262, and a lower grounding tail 265 opposing the lower grounding contact portion 264. The lower signal contact portions 250 of each pair of the signal contacts 25 are disposed between the two adjacent lower grounding contact portions 264 and arranged in a row. The pair of the lower signal conductors 261 are separated by a fifth pitch P5 being substantially equal to the fourth pitch P4. The lower front signal conductor ends 262 are electrically connected with the lower signal tails 251, respectively. The lower front signal conductor ends 262 are directly connected with the lower signal tails 251 by soldering, welding, etc. The lower grounding contacts 260 are integrated with each other by a lower connecting plant 266.

Each of the cable assembly 20 further comprises a plurality of lower cables 27. Each of the lower cables 27 comprises a lower insulative portion 270 with a pair of associated lower signal wires 271 extending lengthwise through the lower insulative portion 270, and a lower ground member 273 associated with the pair of lower signal wires 271. The pair of lower signal wires 271 are separated by a sixth pitch P6 being substantially equal to the fifth pitch P5. The lower ground member 273 and the lower signal wires 271 have opposed first and second free ends, the first free ends of the lower ground member 273 and the lower signal wires 271 being electrically connected with the lower grounding tails 265 and the lower rear signal conductor ends 263 respectively, the second free ends of the lower ground member 273 and the lower signal wires 271 being electrically coupled to the second mating connector. The lower rear signal conductor ends 263 are directly connected with the lower signal wires 271 by soldering, welding, etc. Each of the lower cables 27 is devoid of drain wire. The free ends of the lower signal wires 271 directly contact with the lower rear signal conductor ends 263 being devoid of bending.

Each of the cable assemblies 20 further comprises a lower conductive member 28 comprising a lower receiving portion 280 for receiving and contacting the lower ground members 273 of the lower cables 27, two lower wing portions 281 connected to two opposing sides of the lower receiving portion 280, and a pair of lower spring tabs 282 extending rearwardly and downwardly from the lower receiving portion 280 for press against the lower cables 27.

The interposer 23 further comprises a lower insulative body 238, the lower grounding contacts 260 and the lower signal conductors 261 being molded in the lower insulative body 238. The lower grounding contact portions 264 extend forwardly beyond a front end of the lower insulative body 238. The lower insulative body 238 comprises a lower front portion 2380, a lower rear portion 2381, and a lower middle portion 2382 connected therebetween. The lower front portion 2380 defines three posts 2383 extending forwardly, and two receiving slots 2384 formed between adjacent two of the posts 2383. The lower rear portion 2381 defines a pair of lower bottom grooves 2385 at the bottom, and a pair of lower top grooves 2389 at the top in communication with the pair of rear grooves 2375 for receiving and organizing the cables 22 respectively. The lower middle portion 2382 comprises a lower flat portion 2386 and defines a lower slot 2388 disposed between the lower flat portion 2386 and the lower rear portion 2381. The lower signal conductor 261 molded in the lower flat portion 2387 and exposed in the air. The lower grounding contacts 260 molded in the posts 2383 and the lower flat portion 2387 and exposed in the air. The lower grounding contact portion 264 extend forwardly beyond the posts 2383 and received in the bottom grooves 2379, respectively. The lower connecting plant 266 of the lower grounding contacts 260 received in the lower slot 2388 and exposed in the air. The lower ground member 273 are received in the lower receiving portion 280 and disposed between the lower conductive member 28 and the lower connecting plant 266, the lower wing portions 281 directly connected with the lower flat portion 2387. Each of the lower cables 27 is received in and organized by the lower bottom grooves 2385. The latch beams 253 of the lower insulative member 252 are latched with the lower insulative body 238 along a bottom to top direction to assemble the lower insulative member 252 with the lower insulative body 238 together and make the lower signal tails 251 to directly contact with the lower front signal conductor end 262.

Each of the contact wafers 30 comprises a pair of upper contacts 31 disposed offset along a front to rear direction, a pair of lower contacts 32 disposed offset along the front to rear direction and opposite to the upper contacts 31, and an insulative plate 33 molded on the upper contacts 31 and the lower contacts 32. The wafers 30 are used to transmit low speed signal, control signal, etc.

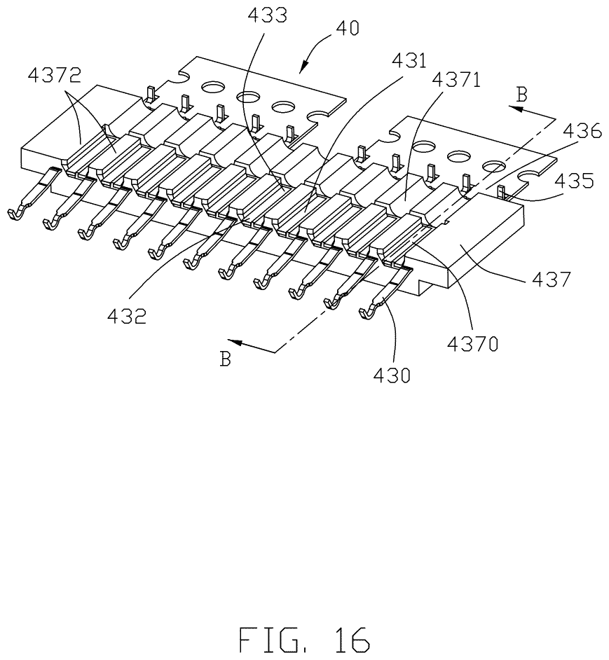

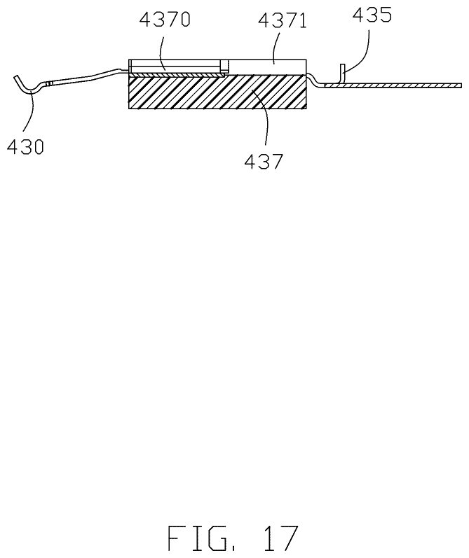

Referring to FIGS. 16 and 17, a second embodiment of the cable assemblies 40 is shown. The insulative body 437 defines a first cavity 4370, second cavities 4371 being in communication with the first cavities 4370, and side walls 4372 at a side or between the first cavities 4370 and the second cavities 4371. The grounding contacts 430 are molded in the side wall 4372 and not exposed in the second cavity 4370. The signal conductors 431 are molded in the insulative body 437 and only exposed in the first cavity 4370. The front signal conductor ends 432 are substantially align with the front end of the first cavity 4370, and the rear signal conductor ends 433 are substantially aligned with a rear end of the first cavity 4370. The first cavity 4370 has a first width lesser than a second width of the second cavity 4371. The grounding contacts 430 also may be exposed in the second cavity 4370. A first distance between the two opposing inner faces of the grounding contacts in the second cavity 4371 is larger than a second distance between the two outside faces of the pair of signal conductors 431 that make the first free end of the ground member may be directly contacted the two opposing inner faces of the grounding contacts 430 in the second cavity 4371. The grounding tails 435 and the connecting plant 436 are exposed in air. The conductive member can be disposed on and contacted with the connecting plant 436. The signal conductors 431 are disposed higher than the connecting plant 436 that make the free ends of the signal wires to directly contact with the rear signal conductor ends 433 being devoid of bending. The cables can be organized in the second cavities 4371.

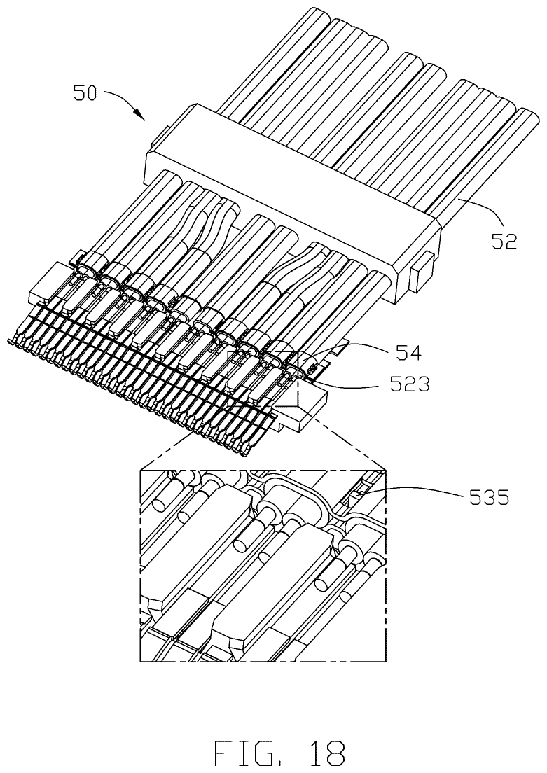

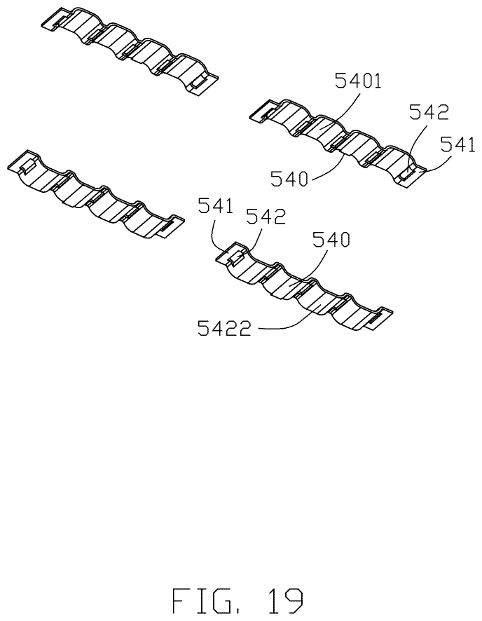

Referring g to FIGS. 18 and 19, a third embodiment of the cable assemblies 50 is shown. The grounding tails 535 extend upwardly. The conductive member 54 comprises receiving portions 540 for receiving and contacting the ground members 523 of the cables 52, and two wing portions 541 connected to two adjacent of the receiving portions 540. The conductive member 54 defining a plurality of holes 542, the grounding tails 535 inserted into the holes 542 to electrically contact with the conductive member 54. The conductive member 54 comprises a first half member 5401 and a second half member 5402 mated with the first half member 5401 cooperated to form the receiving portions 540.

1. A cable assembly comprising:
a pair of signal contacts for transmitting high speed differential signal, the signal contacts comprising signal contact portions and signal tails opposing the signal contact portions, the signal tails being separated by a first pitch;
an interposer comprising a pair of grounding contacts and a pair of signal conductors disposed between the grounding contacts, the signal conductors comprising front signal conductor ends and rear signal conductor ends opposing the front signal conductor ends, the grounding contacts having grounding contact portions extending forwardly beyond the front signal conductor ends and grounding tails opposing the grounding contact portions, the signal contact portions disposed between the grounding contact portions, the signal contact portions and the grounding contact portions arranged in a row, the signal conductors being separated by a second pitch, the front signal conductor ends being electrically connected with the signal tails respectively; and
a cable comprising an insulative portion with a pair of signal wires extending lengthwise through the insulative portion, and a ground member associated with the signal wires, the signal wires being separated by a third pitch, the ground member and the signal wires having free ends electrically connected with the grounding tails and the rear signal conductor ends respectively.

2. The cable assembly as claimed in claim 1, wherein the first pitch is substantially equal to the second pitch, and the second pitch is substantially equal to the third pitch.

3. The cable assembly as claimed in claim 1, wherein the front signal conductor ends are directly connected with the signal tails respectively, and the rear signal conductor ends are directly connected with the signal wires respectively.

4. The cable assembly as claimed in claim 1, further comprising a conductive member comprising a receiving portion for receiving and contacting the ground member of the cable and two wing portions connected to two opposing sides of the receiving portion

5. The cable assembly as claimed in claim 4, wherein the conductive member defines a pair of holes, and the grounding tails extend upwardly into the holes to electrically contact with the conductive member.

6. The cable assembly as claimed in claim 4, wherein the conductive member comprises a first half member and a second half member.

7. The cable assembly as claimed in claim 4, wherein the pair of grounding contacts are integrated with each other by a connecting plant connected therebetween.

8. The cable assembly as claimed in claim 7, wherein the interposer comprises an insulative body, the grounding contacts and the signal conductors being molded in the insulative body, the grounding contact portions extending forwardly beyond a front end of the insulative body, the front signal conductor ends being substantially align with the front end of the insulative body.

9. The cable assembly as claimed in claim 8, wherein the insulative body defines a first cavity, the signal conductors being exposed in the first cavity, the grounding tails and the connecting plant being exposed in air, the conductive member disposed on and contacted with the connecting plant, the signal conductors disposed higher than the connecting plant to make the free ends of the signal wires directly contact with the rear signal conductor ends that are devoid of bending.

10. The cable assembly as claimed in claim 8, wherein the signal contacts are molded in an insulative member, one of the insulative member and the insulative body having keying recesses and the other having keying posts mated with the keying recesses.

11. The cable assembly as claimed in claim 1, further comprising a pair of lower signal contacts for transmitting high speed differential signal, the lower signal contacts comprising lower signal contact portions and lower signal tails opposing the lower signal contact portions, the lower signal tails being separated by a fourth pitch, the interposer comprising a pair of lower grounding contacts and a pair of lower signal conductors disposed between the lower grounding contacts, the lower signal conductors comprising lower front signal conductor ends and lower rear signal conductor ends opposing the lower front signal conductor ends, the lower grounding contacts having lower grounding contact portions extending forwardly beyond the lower front signal conductor ends, and lower grounding tails opposing the lower grounding contact portions, the lower signal contact portions disposed between the lower grounding contact portions, the lower signal contact portions and the lower grounding contact portions arranged in a row, the lower signal conductors being separated by a fifth pitch, the lower front signal conductor ends being electrically connected with the lower signal tails respectively, a lower cable comprising a lower insulative portion with a pair of lower signal wires extending lengthwise through the lower insulative portion, the lower signal wires being separated by a sixth pitch, and a lower ground member associated with the lower signal wires, the lower ground member and the lower signal wires having lower free ends, and the lower free ends of the lower ground member and lower signal wires being electrically connected with the lower grounding tails and the lower rear signal conductor ends respectively.

12. The cable assembly as claimed in claim 11, wherein the fourth pitch is substantially equal to the fifth pitch, and the fifth pitch is substantially equal to the sixth pitch.

13. The cable assembly as claimed in claim 11, wherein the interposer comprises a lower insulative body assembled with the insulative body, and the insulative body defines a plurality of bottom grooves receiving the lower grounding contact portions and the lower signal contact portions.

14. A cable bypass assembly adapted for mating between a first mating connector and a second mating connector near a chip of a device, the cable bypass assembly comprising:
a connector housing adapted for mating with the first mating connector; and
a plurality of cable assemblies received in the connector housing, each of the cable assemblies comprising:
a plurality of pairs of signal contacts arranged in a row, each of the signal contacts comprising a signal contact portion and a signal tail;
an interposer comprising a plurality of grounding contacts and a plurality of pairs of signal conductors, each pair of the signal conductors disposed between adjacent two of the grounding contacts, each of the signal conductors comprising a front signal conductor end and a rear signal conductor end, each of the grounding contacts comprising a grounding contact portion extending forwardly beyond the front signal conductor end and a grounding tail, two signal contact portions of each pair of the signal contacts disposed between two adjacent grounding contact portions, the front signal conductor ends being electrically connected with the signal tails respectively; and
a plurality of cables each comprising an insulative portion with a pair of associated signal wires extending lengthwise through the insulative portion and a ground member associated with the pair of signal wires, the ground member and the signal wires having opposed first and second free ends, the first free ends of the ground member and the signal conductors being electrically connected with the grounding tails and the rear signal conductor ends respectively, the second free ends of the ground member and the signal conductors being electrically coupled to the second mating connector.

15. The cable bypass assembly as claimed in claim 14, further comprising a conductive member comprising a receiving portion for receiving and contacting the ground member of the cables and wing portions connected to two sides of the receiving portions.

16. The cable bypass assembly as claimed in claim 14, wherein the interposer comprises an insulative body, the grounding contacts and the signal conductors being molded in the insulative body, the grounding contact portions extending beyond a front end of the insulative body, the insulative body having a plurality of cavities and a plurality of side walls disposed at a side or between the cavities, each of the cavities comprising a first cavity and a second cavity, the grounding contacts molded in the side walls, each pair of the signal conductors exposed in the first cavity, the cables being organized in the second cavities.

17. The cable bypass assembly as claimed in claim 14, wherein the cable assembly comprises a plurality of pairs of lower signal contacts arranged in a row, each of the lower signal contacts comprising a lower signal contact portion and a lower signal tail, the interposer comprising a plurality of lower grounding contacts and a plurality of pairs of lower signal conductors, each pair of the lower signal conductors disposed between adjacent two of the lower grounding contacts, each of the lower signal conductors comprising lower front signal conductor end and lower rear signal conductor end, each of the lower grounding contacts comprising a lower grounding contact portion extending forwardly beyond the lower front signal conductor ends, and lower grounding tail, two lower signal contact portions of each pair of the lower signal contacts disposed between the two adjacent lower grounding contact portions, the lower front signal conductor ends being electrically connected with the lower signal tails respectively, a plurality of lower cables each comprising an lower insulative portion with a pair of associated lower signal wires extending lengthwise through the lower insulative portion, and a lower ground member associated with the pair of lower signal wires, the lower ground member and lower signal wires having opposed lower first and lower second free ends, the lower first ends being electrically connected with the lower grounding tails and the lower rear signal conductor ends respectively, the lower second free ends of the lower ground member and lower signal wires being electrically coupled to the second mating connector.

18. The cable bypass assembly as claimed in claim 17, wherein the interposer comprises an insulative body comprising an insulative body molded on the grounding contacts and the signal conductors and a lower insulative body molded on the lower grounding contacts and the lower signal conductors.

19. A cable bypass assembly adapted for being connected between a first mating connector and a second mating connector near a chip of a device, the cable bypass assembly comprising:
a connector housing;
a first cable assembly received in the connector housing; and
a second cable assembly received in the connector housing and disposed opposite to the first cable assembly to form a mating area for mating with the first mating connector, each of the first and the second cable assemblies comprising:
a plurality of pairs of signal contacts arranged in a row, each of the signal contacts comprising a signal contact portion and a signal tail;
an interposer comprising a plurality of grounding contacts and a plurality of pairs of signal conductors, each pair of the signal conductors disposed between adjacent two of the grounding contacts, each of the signal conductors comprising a front signal conductor end and a rear signal conductor end, each of the grounding contacts comprising a grounding contact portion and a grounding tail, two signal contact portions of each pair of the signal contacts disposed between the two adjacent grounding contact portions, the front signal conductor ends being directly connected with the signal tails respectively; and
a plurality of cables each comprising an insulative portion with a pair of associated signal wires extending lengthwise through the insulative portion and a ground member associated with the pair of signal wires, the ground member and the signal wires having opposed first and second free ends, the first free ends of the ground member and the signal conductors being electrically connected with the grounding tails and the rear signal conductor ends respectively, the second free ends of the ground member and the signal conductors being electrically coupled to the second mating connector.

20. The cable bypass assembly as claimed in claim 19, further comprising a third cable assembly received in the connector housing and align with the first cable assembly, a fourth cable assembly received in the connector housing and align with the second cable assembly, and a plurality of contact wafers disposed between the first cable assembly and the third cable assembly and between the second cable assembly and the fourth cable assembly, the first to fourth cable assemblies and the contact wafers cooperating to form the mating area.
